(19) United States
(12) Patent Application Publication
(10) Pub. No.: US 2008/0283211 A1
(43) Pub. Date: Nov. 20, 2008

(54) DIRECTIONAL SOLIDIFICATION METHOD FOR INCESSANTLY PRODUCING THE POLYSILICON INGOT AND THE RELATIVE INGOT CASTING PPARATUS

(76) Inventor: Yong-Qiang HONG, Xiamen City (CN)

Correspondence Address: Dr. BANGER SHIA, 102 Lindencrest Ct., Sugar Land, TX, 77479-5201, US

(21) Appl. No.: 12/049,333

(22) Filed: Mar. 16, 2008

(30) Foreign Application Priority Data
May 16, 2007 (CN) 200710008984.8

(51) Int. Cl. B22D 30/00; F27B 9/00

(52) U.S. Cl. 164/122; 432/128

(57) ABSTRACT

The present invention pertains to a method for incessantly producing polysilicon ingots, especially fabricated of an equality polycrystalline material. It contains a metallurgical method for continuously producing large amount of polysilicon ingot made by metal silicon, further comprising the steps of aligning empty graphite molds on furnace cars; preheating the molds in the preheating area; pouring the liquidized silicon into the preheated molds; transporting the molds filled with liquidized silicon from the high-temperature area, thence to a medium-temperature area, and then to a low-temperature area for solidifying the liquidized silicon into crystallized silicon; cooling the crystallized silicon until reaching the room temperature by the assistance of a shroud in a rotary conveyer track, thus generating an integral polysilicon ingot. The apparatus comprises a body, a chamber, a track, cars, a front and rear auxiliary cars, a rotary conveyer track, a propulsion apparatus, and an adjusting system.

### BACKGROUND OF THE INVENTION

1. Field of the Invention

The invention patent relates to a metallurgical method for incessantly manufacturing polysilicon ingot based on the polycrystalline materials and its ingot casting apparatus.

2. Description of the Related Art

Currently, the issue on the solar-grade energy has been highly concerned by relevant industries, and the polysilicon ingot is one of the popular elements applying to the solar cells. In practical, it generally contains two methods for producing polysilicon ingots; one is a heat exchanging method, generally adopted by some famous companies in Japan, Germany, and France, namely melting the raw silicon material by a crucible and then passing it through the bottom of the crucible for proceeding to cool and thereafter form an integral ingot; the other method is to arrange two respective crucibles for melting and cooling the material into the integral ingot. The heating exchanging method may benefit to produce 250 KG of integral ingots, but it has the disadvantages of higher energy consumption, longer periodic time, and only single integral ingot produced by one casting furnace.

Of further method for producing ingots, The China Patent no. CN1873062 discloses a method for producing high dense polycrystalline cell and its apparatus, mainly applying the concatenation of the vacuum electromagnetic induction melting, the plasma oxidation, and the eutectic solidification for manufacturing the solar silicon ingot. Theoretically, the electromagnetic induction reactor mainly describes that the electromagnetic field exchanges outside the materials and the equation as below is required to be satisfied: ‘Q=J2/i’. Further, according to the chemical equilibrium, the equilibrium partial pressure of element is lower than the pressure the atmosphere, thus the vacuum melting method can eliminate the impurities inherent within the liquidized silicon. In view of the theory of metal solidification, the elements having the equilibrium distribution coefficient smaller than 1 are obviated from the liquid.

Additionally, according to the China patent No. CN 85100529, it discloses a process of solidifying the polycrystalline cell, comprising the steps of hanging the graphite molds in time of melting the raw silicon materials; fastening the molds to the rotating shaft and further descending the molds while increasing the water flow speed for water-cooling the melted silicon from the bottomless crucible, thereby producing the integral silicon ingot formed in pillar shape with no holes and cracks therein and the centimeter width. However, the above two cited references can merely produce one silicon ingot per time while utilizing one furnace, thus still requires improvements.

### SUMMARY OF THE INVENTION

The purpose of the present invention is to provide a metallurgical method, which is conducive to incessantly produce large amount of polysilicon ingots, thus improving the conventional method of one ingot produced by one casting apparatus.

Another purpose of the present invention is to provide an ingot casting apparatus applied to cast larger quantities of the integral polysilicon ingots in single producing line.

Furthermore, the ingot casting apparatus of the present invention for incessantly producing polysilicon ingots mainly comprises a furnace body, a furnace chamber disposed therein, furnace cars disposed below the chamber for following a furnace track into the chamber, graphite molds loaded by the cars, a front and a rear auxiliary cars, a rotary conveyer track for controlling the movements of the cars, a propulsion apparatus disposed in front of the furnace entrance, and an electricity and temperature adjusting system disposed outside the body. While in use, the molds are sequentially arranged in the chamber and preheated in the preheating area, further the liquidized silicon is poured into the molds and retains in a high temperature area, thence gently solidified in medium-temperature area, thereafter decreasing the temperature in the low-temperature area, and finally cooled down to the room temperature under the protection of a shroud on the rotary conveyer track, thus finishing the integral ingot. Moreover, the preheated molds loaded by the furnace cars generate a high-low temperature layer therein, and which results of the liquidized silicon therein forming a solid-liquid property from the bottom to the top, which is thereafter solidified into a pillar contour, thus simultaneously eliminating the impurities inside the liquid.

The advantages of the present invention over the known prior art will become more apparent to those of ordinary skilled in the art upon reading the following descriptions in junction with the accompanying drawings.

### BRIEF DESCRIPTION OF THE DRAWINGS

FIG. 1 is a schematic view showing an ingot casting apparatus of the present invention; and

FIG. 2 is a top view showing the ingot casting apparatus of the present invention.

### DETAILED DESCRIPTION OF THE PREFERRED EMBODIMENTS

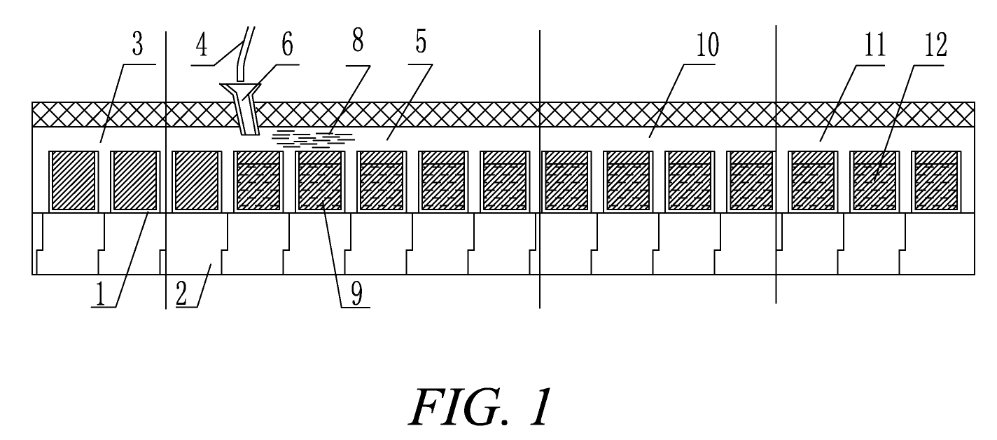

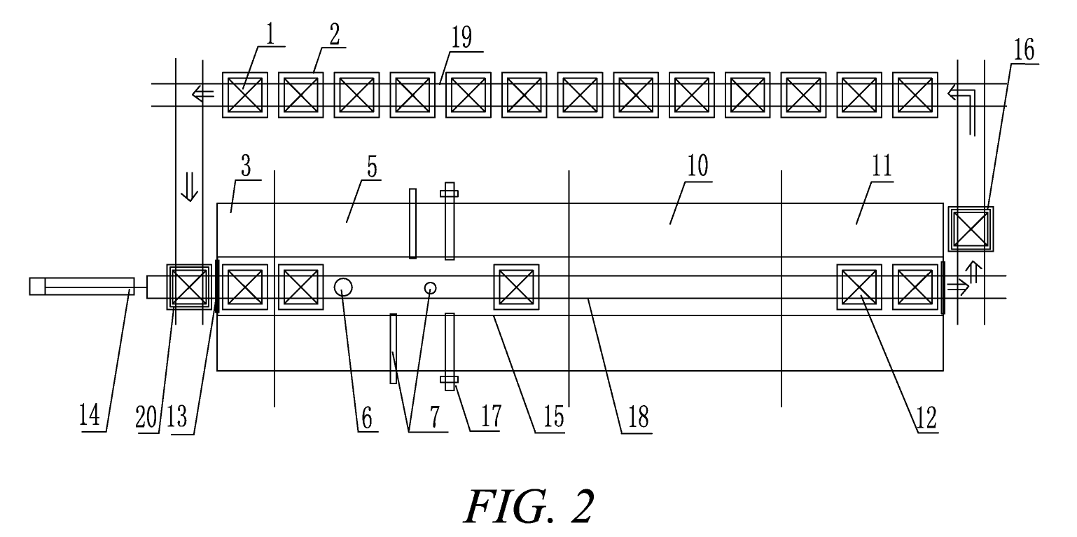

Referring to FIGS. 1 and 2, an ingot casting apparatus of the present invention comprises a furnace body, a furnace chamber 15 disposed therein, furnace cars 2 disposed for loading a plurality of graphite molds 1, a furnace track 18 arranged under the furnace cars 2, a front auxiliary car 20, a rear auxiliary car 16, a rotary conveyer track disposed around the chamber 15 for controlling the movements of the cars 2, a propulsion apparatus disposed in front of the furnace chamber 15, and an electricity and temperature adjusting system disposed outside the body; wherein, the furnace body is sectional and detachable, and both sides thereof have respective windows for users to be aware of the charging status of the liquidized silicon 4.

Still further, the furnace chamber 15 disposed inside the furnace body has a security door at an entrance thereof for preventing the malposition of the cars 2, which can be detected by a protection device, and further comprises in sequence a preheating area 3, a high-temperature area 5, a medium-temperature area 10, and a low-temperature area 11 axially disposed therein, thus generating a high-low temperature layer within the chamber 15 in cross section. The above temperature areas are respectively heated by an electric resistance filament, a SiC heater element, and a MoSi2 heating element and are adjusted by a meter with a PID controller, which are disposed in alignment for communicating with computers and set up the appropriate temperature of each area; further, the high-temperature area 5 has a gas inlet bore 7 disposed thereon for conducting gas to control the atmosphere of liquidized silicon 4, e.g. the Argon gas 8, and the above different temperature areas respectively include outlet gas bore for obviating waste gas, adjusting the furnace pressure and the balance of the gas flow. Additionally, the high-temperature area 5 provides with a furnace hopper 6 attached to a crown thereof and the furnace hopper 6 preferably belongs to a conductive charging hopper fabricated of corundum materials and has an outer sleeve thereon secured to the furnace body and an inner sleeve disposed therein. Both the inner sleeve and the hopper 6 can be replaced if necessary.

Additionally, the furnace cars 2 is disposed below the chamber 15 for loading a plurality of graphite molds 1; each car 2 consists of metal flames with four wheels and heat proofing layers and has proofing sections at the bottom and by the sides thereof for absorbing and discharging the leaking liquidized silicon 4 and also has relieving pieces at the rear thereof for reducing the vibration while the car is intermittently forwarding along the track. Furthermore, the furnace track 18 is arranged at the bottom of the furnace body, under the furnace cars 2; the front auxiliary car 20 is disposed in front of the furnace entrance to help the furnace cars 2 back to the entrance along the rotary conveyer track, and the rear auxiliary car 16 is disposed behind a furnace exit to drive the furnace cars 2 back to the rotary conveyer track 18 while approaching to the furnace exit, further the rotary conveyer track is arranged at both sides of the furnace body for transporting the cars 2 from the exit to the entrance and preferably arranges a shroud adjacent to the exit for proceeding to the cooling procedure. The propulsion apparatus is located in front of said furnace entrance for propelling the furnace cars 2 into the furnace chamber 15 and is utilized by hydrostatic or mechanical propulsions; further the apparatus has a warning device for reminding of the abnormal state in operation.

Still, the graphite molds 1 loaded by the furnace cars 2 are applied to be resistant to oxidation, namely the molds 1 can have their outer and inner surfaces coated with either Silicon Nitride (Si3N4) or Boron Nitride (BN) as an antioxidant, have the inner surfaces coated with Silicon Nitride (Si3N4) and the outer surfaces coated with Boron Nitride (BN), or have the inner surfaces coated with Boron Nitride (BN) and the outer surfaces coated with Silicon Nitride (Si3N4). Here it is adopted to have the inner surfaces coated with Silicon Nitride (Si3N4) and the outer surfaces coated with Boron Nitride (BN).

Referring to FIGS. 1 and 2, while in operation, the empty graphite molds 1 are sequentially disposed on the furnace cars 2, which are then forwarded by the front auxiliary car 20 to the front of the furnace door 13, and the propulsion apparatus 14 pushes the car 20 into the chamber 15, whereby preheating the molds 1 on the furnace cars 2 in the preheating area 3 at the temperature from 1200 degree C. to 1600 degree C. for 2 to 6 hours; then pouring the liquidized silicon 4 into the preheated molds 1 by the furnace hopper 6 and retaining the molds 1 in the high-temperature area 5 in a high temperature range of 1400 degree C. to 1600 degree C. for 2 to 8 hours; simultaneously the Argon atmosphere 8 is conducted therein through the gas inlet bore 7. Thereafter, the molds 1 are forwarded from the high-temperature area 5 to the medium-temperature area 10 in a temperature range from 1100 degree C. to 1300 degree C., for 10 to 30 hours, thus obtaining crystallized silicon therein, and thereafter the molds 1 are transported to the low-temperature area 11 in the temperature gradient range between 600 degree C. and 800 degree C. Then the rear auxiliary car 16 helps pushing the cars 2 back to the rotary conveyer track and the crystallized silicon is cooled until reaching the room temperature under the assistance of the shroud of the rotary conveyer track, thus generating an integral polysilicon ingot, and which requires 20 to 50 hours for an entire producing process. Furthermore, the furnace cars 2 still shuttles on the track when in turn to the furnace door 13. Therefore, the preheated molds loaded by the furnace cars generate a high-low temperature layer therein, and which results of the liquidized silicon 4 therein forming a solid-liquid property from the bottom to the top, which is thereafter solidified into a pillar contour, thus simultaneously eliminating the impurities inside the liquid.

According to the aforementioned, the present invention has following advantages:

1. Producing without interruption

By means of the configuration of the rotary conveyer track, the present invention incessantly produces large amount of integral ingot per time, so as to overcome the problem of lower quantities, longer period manufacturing time, and merely one ingot produced by single casting furnace occurred in the conventional method.

2. Retaining lower energy consumption and manufacturing cost

The arrangements of different temperature areas in the furnace chamber facilitate to maintain the temperature in a certain range and thereafter gradually cool the graphite molds by passing therethrough, which results of consuming less energy and lowering the cost of production.

3. Higher yield rate

In view of the sequential arrangement and intermittent movement of the furnace cars and accompanying with the temperature adjusting system, the present invention maintain to produce the integral polysilicon ingots by the same producing line, thereby increasing the producing stability and obtaining higher yield rate.

4. Uncomplicated equipments and technology

According to the aforementioned method, the present invention utilizes single equipment and facile manipulations for increasing the quantities of the ingots, for instance of producing more than 200 tons of ingots by single furnace per year, whereby the method can efficiently decrease the costs.

To sum up, the present invention mainly has a rotary device disposed around the furnace body for intermittently inching the graphite molds from the high-temperature area to the low-temperature area thereby, thus adjusting the solidification of the crystallized by means of the forwarding speed of the cars and the differentiated temperature among the areas of the chamber. Further, the preheated molds loaded by the furnace cars generate a high-low temperature layer therein to result of the liquidized silicon therein forming a solid-liquid property, which is thereafter solidified into a pillar contour and thence cooled until reaching the room temperature, thus the integral polysilicon ingot is finished and simultaneously the rotary conveyer track assists to continuously produces ingots while manipulating.

While we have shown and described the embodiment in accordance with the present invention, it should be clear to those skilled in the art that further embodiments may be made without departing from the scope of the present invention.

I claim:

1. A directional solidification method for incessantly producing polysilicon ingot comprising the steps of:
axially and sequentially arranging a plurality of empty graphite molds in alignment on furnace cars; said molds being driven by removals of said cars along with a furnace track within a furnace chamber and preheated in a temperature range from 1200 degree C. to 1600 degree C. while traveling in a preheating area of said furnace chamber;
pouring a certain amount of liquidized silicon from a furnace hopper into said preheated molds; wherein, said furnace hopper being disposed on a crown of a high-temperature area, located within said furnace chamber, and said high-temperature area maintaining a high temperature range from 1400 degree C. to 1600 degree C.;
retaining said molds filled with said liquidized silicon in said high-temperature area for 2 to 8 hours;
transporting said molds filled with said liquidized silicon from said high-temperature area to a medium-temperature area for 10 to 30 hours, thereby gradually solidifying said liquidized silicon to form crystallized silicone; wherein, said medium-temperature disposed in said furnace chamber area having a medium temperature range from 1100 degree C. to 1400 degree C.;
forwarding said crystallized silicon in said molds through a low-temperature area for 10 to 20 hours and decreasing said medium temperature gradient within a temperature range between 600 degree C. and 1000 degree C.; wherein, said low-temperature area disposed in said furnace chamber having a low temperature range from 600 degree C. to 1100 degree C.; and thereafter
cooling said crystallized silicon inside said molds gradually from said low temperature to a room temperature under an assistance of a shroud in a rotary conveyer track, thus generating an integral solidification of polysilicon ingot.

2. The directional solidifying method for incessantly producing polysilicon ingot as claimed in claim 1, where, some Argon gas is conducted into said high-temperature area for controlling an atmosphere of said liquidized silicon.

3. The directional solidifying method for incessantly producing polysilicon ingot as claimed in claim 1, wherein, said empty graphite molds are resistant to oxidation.

4. The directional solidification method for incessantly producing polysilicon ingot as claimed in claim 3, wherein, said empty graphite molds have their outer and inner surfaces coated with either Silicon Nitride (Si3N4) or Boron Nitride (BN) as an antioxidant.

5. The directional solidification method for incessantly producing polysilicon ingot as claimed in claim 3, wherein, said empty graphite molds have their inner surfaces coated with Silicon Nitride (Si3N4) and their outer surfaces coated with Boron Nitride (BN).

6. The method of directional solidification for incessantly producing polysilicon ingot as claimed in claim 3, wherein, said empty graphite molds have their inner surfaces coated with Boron Nitride (BN) and their outer surfaces coated with Silicon Nitride (Si3N4).

7. An ingot casting apparatus for incessantly producing polysilicon ingots comprising:
a furnace body; wherein, said furnace body being sectional and detachable;
a furnace chamber disposed inside said body; wherein, said chamber comprising in sequence a preheating area, a high-temperature area, a medium-temperature area, and a low-temperature area axially disposed therein; said high-temperature area having a furnace hopper attached to a crown thereof for pouring liquidized silicon in;
a plurality of furnace cars disposed below said furnace chamber for loading a plurality of graphite molds;
a furnace track arranged under said furnace cars, by which said cars can follow said track into said furnace chamber;
a front auxiliary car disposed in front of a furnace entrance for assisting said furnace cars back to said entrance;
a rear auxiliary car disposed behind a furnace exit for driving said furnace cars back to said rotary conveyer track;
a rotary conveyer track disposed at both sides of said furnace body for transporting said furnace cars from said exit toward said entrance;
a propulsion apparatus disposed in front of said furnace entrance for propelling said furnace cars forward into said furnace chamber; wherein, said apparatus can be utilized by hydrostatic or mechanical propulsions; and
an electricity and temperature adjusting system disposed outside said furnace body.

8. The ingot casting apparatus for incessantly producing polysilicon ingots as claimed in claim 7, wherein, said furnace hopper is a conductive charging hopper for pouring said liquidized silicon into said graphite molds.

9. The ingot casting apparatus for incessantly producing polysilicon ingots as claimed in claim 7, wherein, said furnace hopper has a hopper outer sleeve disposed thereon, and said hopper outer sleeve is secured to said furnace body.

10. The ingot casting apparatus for incessantly producing polysilicon ingots as claimed in claim 8, wherein, said furnace hopper has a hopper outer sleeve disposed thereon, and said hopper outer sleeve is secured to said furnace body.

11. The ingot casting apparatus for incessantly producing polysilicon ingots as claimed in claim 6, wherein, said rotary conveyer track adjacent to said furnace exit includes a shroud arranged thereon.
